(19) United States
(12) Patent Application Publication
(10) Pub. No.: US 2013/0156506 A1
(43) Pub. Date: Jun. 20, 2013

(54) Method for Renewal or Rehabilitation of Water Supply Pipelines and Plug Arrangement for use in Said Method

(71) Applicant: Rolf Ivar Dalby, Engelsviken (NO)

(72) Inventor: Rolf Ivar Dalby, Engelsviken (NO)

(73) Assignee: OLINER SYSTEM LLC, New York, NY (US)

(21) Appl. No.: 13/331,755

(22) Filed: Dec. 20, 2011

(51) Int. Cl. F16L 55/18; F16L 55/11

(52) U.S. Cl. 405/184.2; 138/89

(57) ABSTRACT

Method for renewal or rehabilitation of water supply pipelines without the need for excavation of the pipes or associated side inlets, manholes, etc., wherein plug arrangements are installed in side inlets, a flexible hose applied with adhesive is threaded into the water supply pipeline, and certain pressure is maintained for a predetermined period of time in order to get the adhesive material hardened and the hose glued to the inner pipe wall, and wherein the mounted plug arrangements are removed. A special plug arrangement for use in said method is also provided.

### BACKGROUND OF THE INVENTION

1. Field of the Invention

The present invention relates to a special plug for use in a new method or process for renewal/rehabilitation of water supply pipelines. Particularly, the invention relates to a special plug for use in a new method for renewal or rehabilitation of drinking water pipelines without digging, so-called “NoDig” method. Such methods comprise installation of an inner lining in old water pipes, which constitutes a new, self-supporting tube or pipe in a “sandwich” construction with the old water supply pipe or pipeline.

2. Related Technology

Conventional excavation and replacement of pipes in the ditch is frequently used, but the “NoDig” methods are developing rapidly. Pipe replacement or rehabilitation with minimal or no excavation is very interesting, as it is reducing the costs, minimizing the environmental impact and disadvantages for the public and reducing the construction and/or water-cut time for the subscribers.

A typical Norwegian water supply system is built up comprising manholes and connecting points (side inlets or tappings), between the manholes or shafts, for supplying water to the subscribers. The manholes can be used for water extraction in connection with firefighting operations and for handling of valves in connection with tasks related to operation and maintenance of the pipeline system.

During its exploitation time of over 100 years the pipelines are exposed for both internal and external corrosion attacks and/or damages, providing holes in the pipes and water leaks or leakages. In Norway it is not uncommon with a 30-50% leakage loss of the produced water. Having an operational pressure of 5-8 bars, this can be resulting in significant water losses, which also can cause significant damages to some urban areas.

There are some “NoDig” methods on the market for renewal of water pipeline systems. These are methods related to systems comprising pipes, hoses, casings, sleeves, etc., which, after some specified procedures, are brought into the old pipe. However, most of these methods require point-excavation at the manholes and side inlets (tappings). For drinking water pipelines there is one known method, that is also available in Norway and that does not require excavation of the tapping point (NCC Construction AS-Polyurethane coating), is using only spraying of an internal coating onto the old pipe. This requires however a significant residual strength of the old pipe, and is in principle “sealing” up only the water from the inner surface of the old pipe.

### SUMMARY OF THE INVENTION

One goal of the present invention can be to provide a special plug for use with our new “NoDig” method.

Another goal of the present invention can be to improve our new “NoDig” method, where excavation of connecting or tapping points between manholes or shafts is avoided and where minimal cross section reduction of the old pipe is achieved.

Our new “NoDig” method can rehabilitate or renew water pipes having a significant reduction in residual strength, and be performed in a cost-efficient manner, wherein the end product meets all strict security requirements.

The aims or goals of the present invention are achieved by a special plug used in a method for renewal/rehabilitation of water pipelines with no requirement for excavation of the pipes or the therewith associated side inlets/tappings, manholes/shafts, etc.

Accordingly, the invention provides a plug arrangement for use in a method for renewal or rehabilitation of water supply pipelines, or a predetermined section or length thereof that is to be rehabilitated, without the need for excavation of pipes, or associated side inlets or tappings, manholes or shafts, etc., wherein the plug arrangement comprises an optional plugging portion adapted to be inserted into a tapping point or side inlet and a covering or collar-shaped portion having a predetermined suitable shape with a peripheral area or surface adapted to cover, around the tapping point, a certain or predetermined area of the inner wall of a pipeline.

The invention relates also to a method for renewal/rehabilitation of water pipelines using the special plug according to the present invention.

Accordingly, the invention provides a method for renewal or rehabilitation of water supply pipelines, or a predetermined section or length thereof that is to be rehabilitated, without the need for excavation of pipes, or associated side inlets or tappings, manholes or shafts, etc., comprising the following steps:

mounting or installing a plug arrangement from inside a water supply pipe or pipeline to cover each of a number of tapping points or side inlets of the pipe or pipeline or a predetermined section or length thereof that is to be rehabilitated,

putting or drawing a flexible hose or tubing saturated or applied with adhesive into the pipeline or pipe length,

applying and maintaining pressure for a predetermined period of time, wherein the applied pressure is high enough to be able to keep the flexible hose or tubing pressed or forced towards the inner wall of the pipeline or pipe length, and wherein the predetermined period of time is long enough so that the adhesive material gets hardened and the hose gets firmly glued onto the inner pipe wall, and

detecting and removing each mounted plug arrangement from inside the pipeline or pipe length.

### BRIEF DESCRIPTION OF THE DRAWINGS

In the following, the invention will now be explained with reference to the enclosed drawings, where:

FIG. 1 shows a drinking water supply pipeline system, preferably in an urban area,

FIG. 2 illustrates a leak or leakage in a main water pipe of a drinking water supply pipeline system according to FIG. 1,

FIG. 3 shows a water pipe that is renewed/rehabilitated according to our new “NoDig” method,

FIGS. 4a, 4b, 4c, and 4d show a step-by-step method for renewal/rehabilitation of water pipelines at a connecting or tapping point using a special plug according to the present invention,

FIG. 5 shows in detail the special plug according to the present invention and a tool for installation of said plug, and

FIGS. 6a and 6b show another embodiment of the special plug arrangement according to the present invention arranged at the connection point of the main water pipe.

### DETAILED DESCRIPTION

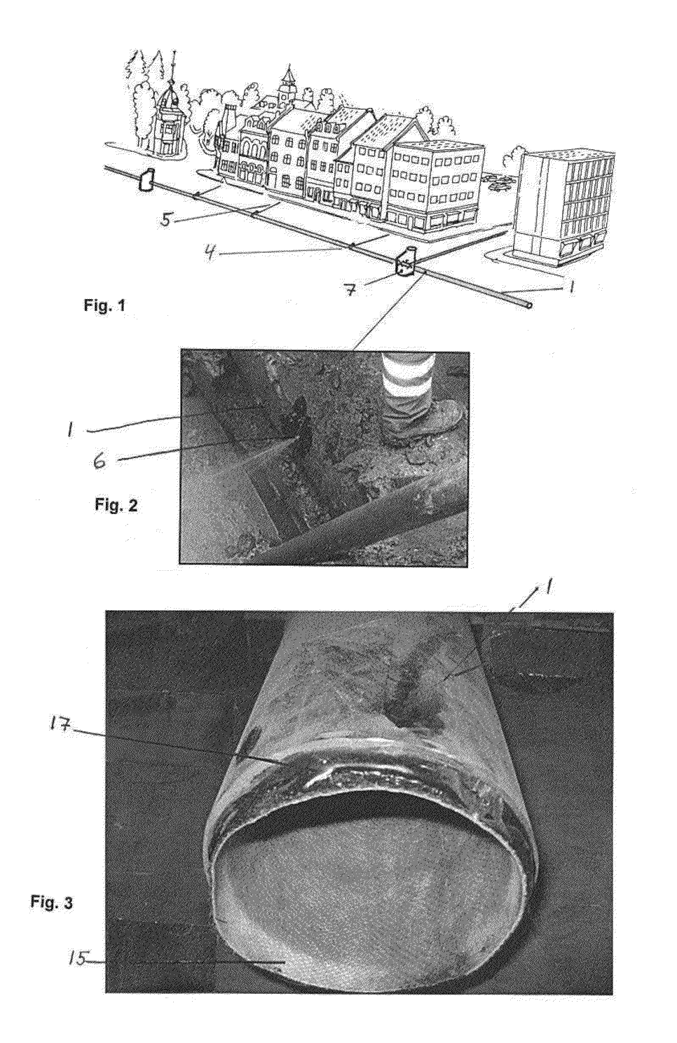

With reference to FIG. 1, a typical drinking water supply pipeline system in an urban area is shown. The system comprises a main water supply pipe or pipeline 1 passing between waterworks shafts or manholes 7. A number of side inlets or tappings 4 for private house pipes 5 are arranged in the water supply pipeline between the manholes 7.

In FIG. 2 an excavated water pipe 1 is shown, which is heavily corroded or otherwise damaged, so that a leak or leakage 6 has occurred.

FIG. 3 shows a water pipeline 1, or a predetermined section or length thereof, which has been renewed/rehabilitated according to our “NoDig” method. In this method a flexible hose or tubing or sleeve 15 is applied or saturated with a suitable adhesive 17 and is put or drawn into the pipe or pipeline 1, by e.g. threading it into or turning it inside out into the pipe or pipeline 1 by using a certain or predetermined air pressure (inserting pressure of e.g. from about 0.5 to about 5.0 bars). The installed hose or tubing 15 is maintained with a suitable predetermined air or water pressure (hardening pressure of e.g. from about 0.5 to about 5.0 bars) for a certain or predetermined period of time, e.g. from about 12 to about 48 hours, particularly from about 15 to about 30 hours, and more particularly from about 20 to about 25 hours, and even more precisely about 24 hours, in order to keep the hose or tubing 15 firmly pressed towards the inner wall 2 of the pipe. During this period of time, hardening of the suitable adhesive material 17 occurs or takes place, and the hose 15 is thus being firmly glued onto the inner wall 2 of the pipe.

All connecting or tapping points are located in advance, and a specially designed plug arrangement 10 is mounted therein for securing the tapping hole 4 against entry of adhesive material 17 into the private house pipe during the installation phase. The plug arrangement 10 comprises a plugging part or portion, e.g. made of rubber, and a collar-shaped part or portion 11 providing for good contact against the inner wall 2 of the pipe or pipeline. After the hose 15 is fully hardened, the installed plugs 10 are being removed by e.g. cutting away or milling out. The end terminations of the hose can be secured or assembled with the help of a clamping ring, made of steel (e.g. stainless steel) or other suitable synthetic materials, in order to secure the hose 15 against detaching from the pipe wall 2.

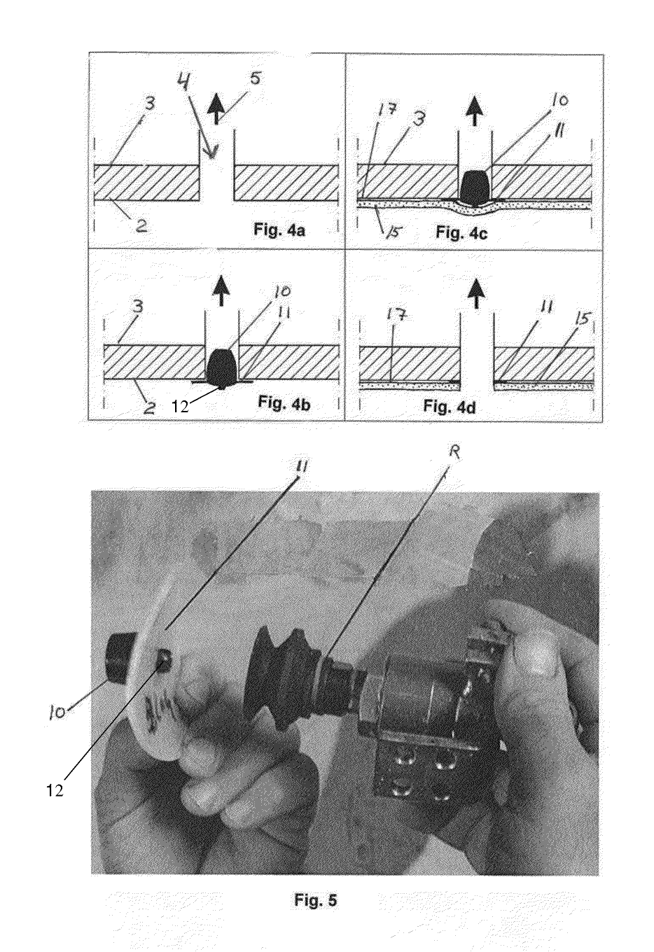

FIGS. 4a, 4b, 4c, and 4d illustrate the four phases or steps for preparation of a tapping or connecting point 4. The four phases or steps are, respectively: cleaning; installation of the special plug 10, installation of the hose or tubing 15 and reopening of the tapping point 4. FIG. 4a shows an old pipe which can have an outer diameter from about 80-100 mm or about 3″ to about 400 mm or about 16″ and with an inner pipe wall 2 and an outer pipe wall 3. The tapping point 4 is shown with an arrow and a private house pipe 5 is indicated with another arrow. FIG. 4b shows the special plug arrangement comprising a plugging part or portion 10 and a collar-shaped portion or part 11, wherein the plugging part or portion 10 is being installed or arranged into the tapping point 4, which is also leading towards the private house pipe, and the collar-shaped portion or part 11 is having a predetermined suitable shape, e.g. circular, elliptical, rectangular, etc., with a peripheral area or surface being able to cover, around the tapping point, a certain or predetermined area of the inner wall 2 of the pipe, or in other words a certain or predetermined periphery area of the tapping point 4. The area of the collar-shaped portion or part 11, being on the same side as the plugging part or portion 10 and facing the inner wall 2 of the pipe, can be saturated or applied with an adhesive in order to contribute to the total sealing associated with the tapping point 4. The collar-shaped portion or part 11 can be substantially flexible so that it would be able to fit with or take the form or shape of the inner wall 2 of the main pipe or pipeline. The surface for the predetermined suitable shape of a collar-shaped portion or part 11 can be substantially flexible and flat, or alternatively substantially flexible and/or curved or (3D/three dimensional) formed into the form or shape of the inner wall 2 of the main pipe. The collar-shaped portion or part 11 can have a thickness from about 1 mm to about 10 mm. The plug arrangement can further comprise a marking means 12 that can be detectable by e.g. a robot arrangement R that can be adapted or adjusted for moving inside the pipeline 1 and for removing the plugs by e.g. using a cutting or milling tool for cutting around the marking means 12 with a predetermined radius dependent on the diameter of the tapping point 4 and/or the private house pipe or connection 5. The marking means 12 is arranged in such a way onto or within the plug arrangement, so that it would be able to define the center of the tapping point or hole 4. The marking means 12 can be physical (e.g. a small permanent magnet or a metal piece, screw or pin, a small hole, cavity or recess, etc.) or chemical (e.g. encapsulated radioactive or radiating material(s) in small amounts that are not harmful for people, etc.) and can be integrated onto or within the plug arrangement, e.g. associated with the side of the collar-shaped part 11 that is facing the flexible hose or tubing 15, or in other words the center of the main pipe or pipeline. FIG. 4c shows the flexible hose or tubing 15 that is applied or saturated with an adhesive or adhesive layer 17 and that has been carried through the pipe and forced or pressed against the inner pipe wall 2 and the collar-shaped part 11 of the plug arrangement 10. FIG. 4d shows the tapping point 4 and the fitted collar-shaped part 11 that has left of the plug arrangement after the cutting or milling operation.

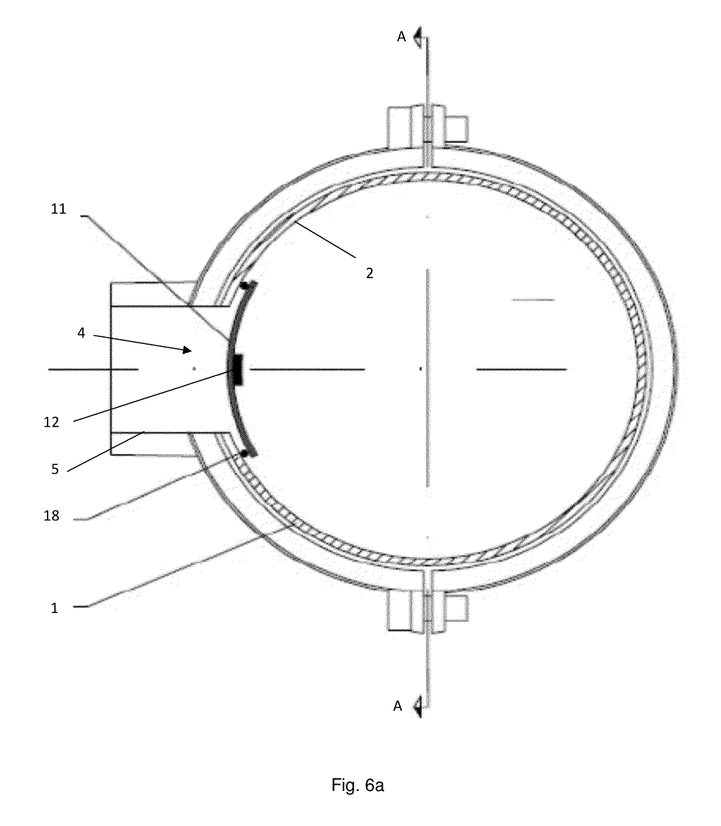

FIG. 5 shows the special plug arrangement 10 comprising the plugging part 10, the collar-shaped part 11 and the marking means 12, that is provided or adapted for placing or arranging in the tapping or side inlet with help of installation or mounting equipment placed on a robot or robot arrangement R, which can be controlled by a remote controlled video camera.

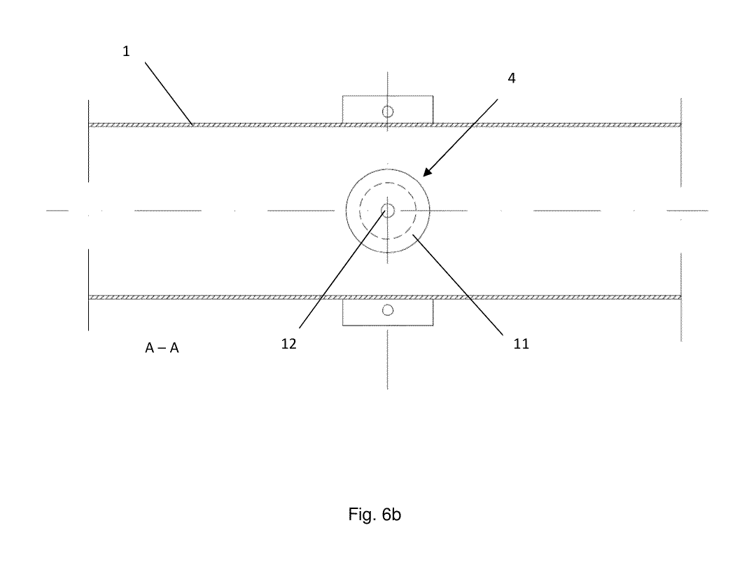

FIGS. 6a and 6b show another embodiment of the special plug arrangement 11 according to the present invention arranged at the connection point 4 of the main water pipe or pipeline 1. FIG. 6a is a cross section of the main water pipe or pipeline 1 at the connection point 4 and shows also a part of the private house pipe 5. Another embodiment of the special plug arrangement 11 is shown in FIG. 6a, wherein the plug arrangement 11 comprises a covering portion or part 11 having a predetermined suitable shape, e.g. circular (shown is FIG. 6b), elliptical, rectangular, etc., with a peripheral area or surface being able to cover, around the tapping point, a certain or predetermined area of the inner wall 2 of the pipe, or in other words a certain or predetermined periphery area of the tapping point 4. The plug arrangement 11 further comprises the marking means 12 as described above. At least part of the aria of the covering portion or part 11, facing the inner wall 2 of the pipe 1, can be saturated or applied with an adhesive and/or sealing ring 18 made of suitable adhesive material in order to contribute to the total sealing associated with the tapping point 4. The covering portion or part 11 can be substantially flexible so that it would be able to fit with or take the form or shape of the inner wall 2 of the main pipe or pipeline 1. The surface for the predetermined suitable shape of the covering portion or part 11 can be substantially flexible and flat, or alternatively substantially flexible or rigid and/or curved or (3D/three dimensional) formed into the form or shape of the inner wall 2 of the main pipe or pipeline 1. The covering portion or part 11 can have a thickness from about 1 mm to about 10 mm. FIG. 6b shows a sectional cut A-A as shown in FIG. 6a.

The installation method can comprise the following steps:

1. Fittings in manholes or shafts 7 are being released or disengaged in order to achieve or obtain direct access to the water supply pipe or pipeline 1.

2. The old pipe or pipeline 1 is being cleaned by e.g. high pressure washing or flushing.

3. All tapping or connection points 4 are being accurately located.

4. Plug arrangement 10, 11 is mounted or installed into or onto each of said tapping points 4 by means of a robot or robot arrangement R, which can be transportable or movable inside the main pipe or pipeline 1 and controlled remotely and/or wirelessly. For the positioning and/or mounting processes of the special plug arrangement 10, 11 a camera, e.g. a video camera, can be used, wherein the camera can also be remote-controlled. Furthermore, the camera can be mounted on the robot or robot arrangement R. The purpose or aim is to prevent entry of adhesive material 17 into the tapping point 4, see point 5 below.

5. Hose or tubing 15, being in advance or on site applied or saturated with an adhesive 17, is being put or drawn into the pipe or pipeline 1, by e.g. threading it into or turning it inside out into the pipe or pipeline 1 by using a certain or predetermined air pressure also called as inserting pressure (e.g. from about 0.5 to about 5.0 bars).

6. The hose or tubing 15 is being held under suitable pressure also called as curing or hardening pressure (of e.g. from about 0.5 to about 5.0 bars) for e.g. from about 12 to about 48 hours, particularly from about 15 to about 30 hours, and more particularly from about 20 to about 25 hours, and event more precisely about 24 hours, wherein the pressure is high enough to be able to get the hose or tubing 15 totally or completely hardened into a firm contact with the inner wall 2 of the pipe.

7. Terminations or termination ends of the hoses and/or pipes in the manholes or shafts 7 are being secured by mounting or installing of a clamp or clamping ring, e.g. made of steel (e.g. stainless steel) or other suitable synthetic materials.

8. Rehabilitated section of the main pipeline 1 is being filled with clean water, and the pipeline system is being pressure-tested according to existing regulations or rules for clean water supply and/or main water pipelines.

9. The mounted or installed plugs or plug arrangements 10, 11 in the tapping points 4 are being detected and milled or cut away (from inside the pipeline).

10. The rehabilitated pipeline 1 can be disinfected.

The mounting or installation of the plug arrangement 10, 11, comprising a plugging portion 10 and a collar-shaped portion 11, into each tapping point 4 can be done by means of a robot or robot arrangement R being adapted or able to move inside the pipeline 1 and having mounted thereon suitable or appropriate tools for different tasks or operations, such as e.g. assembling arm or tool, etc., that can be controlled remotely and/or wirelessly, and can further comprise the following steps: detecting a tapping or connection point 4, inserting the plugging portion 10 into the tapping hole or point 4 until the collar-shaped portion 11, or at least some part thereof, comes into contact with at least some part of a certain or predetermined area of the inner pipe wall 2 around the tapping point or hole 4. At least a part of the surface area of the collar-shaped portion 11 facing the inner pipe wall 2 can be applied or saturated with an adhesive so that, prior or during the hose or tubing hardening process, a very good and tight sealing will be created or provided around or in the tapping point, and/or between the layers of the rehabilitated pipe therein, and/or through or throughout the tapping point towards or in the proximity of the private house pipe. In addition entry of adhesive material 17 into the tapping point 4 will be prevented. For monitoring of these operations or processes and/or for guiding or controlling of the robot arrangement R a (video) camera can be used, wherein the camera can also be remote-controlled and/or can be mounted on the robot arrangement R.

In an alternative embodiment of the plug arrangement, the mounting or installation of the plug arrangement 10, 11, can further comprises the following steps: detecting a tapping or connection point 4; placing the collar or covering portion 11 onto each tapping point 4 so that at least some part of the collar or covering portion 11 comes into contact with at least some part of a certain or predetermined area of the inner pipe wall 2 around the tapping point or hole 4, wherein at least a part of the surface area of the covering or collar portion 11, facing the inner pipe wall 2, is applied or saturated with an adhesive 18 so that tight sealing is created or provided around and throughout the tapping point.

The milling or cutting of the mounted or installed plug arrangements 10, 11, further comprising marking means 12, can further comprise the following steps: detecting the marking means 12 and cutting around the marking means 12 with a predetermined radius dependent on the diameter of the tapping point 4 and/or the private house pipe or connection 5. This milling or cutting operation or step can be done by means of a robot arrangement R having mounted thereon suitable or appropriate tools for different tasks or operations, e.g. milling or cutting tool, detecting means etc., that can be controlled remotely and/or wirelessly.

The remote-controlled robot arrangement or robot R can enter the water supply pipeline 1 at a suitable place, such as e.g. one manhole or shaft 7.

The flexible hose or tubing 15 can be flat or folded prior to installing and/or can be rolled on a drum. In addition the hose or tubing 15 can also be introduced into the pipeline or pipe section/length 1 at a suitable place, such as e.g. one manhole or shaft (7).

The testing of the rehabilitated pipeline can be done by exposing it, for a certain period of time being defined by the respective responsible country authorities, to a constant pressure of e.g. up to about 15 bars. The constant pressure can also be defined by the respective responsible country authorities.

Some tests have been done and are described below. However, the invention should not be limited to the dimensions mentioned below. The tests have been run using a standard pipe having the following specifications: nominal bore 8 inch (DN 200 mm), outside diameter 219.1 mm. The standard steel pipe has been perforated with 5 pieces of DN 8 mm holes in order to control or check the method's ability to seal the rusted holes in old pipes. There has also been made 2 pieces of side inlets in order to test the special plug arrangement and its sealing and/or waterproofing abilities or properties, and also to test the adhesive sealing and/or waterproofing abilities or properties between the old pipe and the hose or tubing, after drilling through the steel pipe, tubing and adhesive, and finally to test the sealing and/or waterproofing qualities in the connection point. Another test has been done with a standard steel pipe having 2 mm to 5 mm perforations and one of 30 mm, and two side inlets.

The installation procedure or method is developed with the applicant's special expertise and equipment or tools, such as e.g. the robot, thereto mounted equipment, the special plug arrangement, etc. Methods and products for water supply pipeline installations are more demanding than and differ significantly from those for drainage or sewerage systems, due to e.g. hygienic conditions and/or requirements as well as requirements for pressure and/or access.

The flexible hose or tubing 15 can have i.a. high strength, good corrosion resistance, good weldability. The tubing can be mounted or installed through angular deflections of e.g. about up to 90 degrees.

The flexible hose or tubing 15 can be built up with an inside coating of polyethylene or other suitable material that is approved for contact with drinking water, and can have exterior polyester tissue or coating with good saturation properties for the adhesive. The hose or tubing 15 can for example be a polyester reinforced hose with extruded polyethylene on one side. Before installation the hose 15 is being saturated or impregnated with any suitable for this purpose adhesive on the market. Other suitable synthetic materials can be used for the flexible hose or tubing 15 as well as other suitable reinforcement materials can be used for the reinforcement of the flexible hose or tubing 15.

There are the many adhesives or adhesive materials on the market. When choosing the adhesive(s) one should also have in mind that the adhesive 17 should among other things have satisfactory hardening properties and/or behavior.

1. Method for renewal or rehabilitation of water supply pipelines, or a predetermined section or length thereof that is to be rehabilitated, comprising:
mounting or installing a plug arrangement from inside a water supply pipe or pipeline to cover each of a number of tapping points or side inlets of said pipe or pipeline or a predetermined section or length thereof that is to be rehabilitated,
putting or drawing a flexible hose or tubing saturated or applied with adhesive into said pipeline or pipe length,
applying and maintaining pressure for a predetermined period of time, wherein the applied pressure is high enough to be able to keep the flexible hose or tubing pressed or forced towards an inner wall of said pipeline or pipe length, and wherein the predetermined period of time is long enough so that the adhesive material gets hardened and the hose gets firmly glued onto the inner pipe wall, and
detecting and removing each mounted plug arrangement from inside said pipeline or pipe length.

2. Method according to claim 1, wherein the plug arrangements are being mounted/installed and removed by a remote-controlled robot arrangement that enters the water supply pipeline at a suitable place and is adapted or able to move inside the pipeline.

3. Method according to claim 1, wherein the plug arrangement comprises a plugging portion and a collar-shaped portion, and wherein the mounting or installation of the plug arrangement into each tapping point further comprises detecting a tapping or connection point; inserting the plugging portion into the tapping hole or point until the collar-shaped portion, or at least some part thereof, comes into contact with at least some part of a certain or predetermined area of the inner pipe wall around the tapping point or hole, wherein the surface area of the collar-shaped portion facing the inner pipe wall is applied or saturated with an adhesive so that tight sealing is created or provided around and throughout the tapping point.

4. Method according to claim 1, wherein the plug arrangement comprises a covering, and wherein the mounting or installation of the plug arrangement onto each tapping point further comprises detecting a tapping or connection point; placing the covering portion onto each tapping point so that at least some part of the covering portion comes into contact with at least some part of a certain or predetermined area of the inner pipe wall around the tapping point or hole, wherein at least a part of the surface area of the covering portion facing the inner pipe wall is applied or saturated with an adhesive so that tight sealing is created or provided around and throughout the tapping point.

5. Method according to claim 1, wherein the plug arrangement comprises a marking means, and wherein the milling or cutting of the mounted or installed plug arrangements further comprises detecting the marking means, and cutting around the marking means with a predetermined radius dependent on the diameter of the tapping point and/or the private house pipe or connection.

6. Method according to claim 1, wherein the flexible hose or tubing is being introduced into said pipeline or pipe length at a suitable place.

7. Method according to claim 1, wherein terminations or termination ends of the flexible hose or tubing are secured by a clamp or clamping ring against the inner pipe wall.

8. Method according to claim 1, further comprising testing the rehabilitated pipeline or pipe section by filling it with clean water and pressure-testing it according to existing regulations or rules for clean water supply and/or main water pipelines.

9. Method according to claim 1, further comprising disinfecting the rehabilitated pipeline or pipe section.

10. Plug arrangement for use in a method for renewal or rehabilitation of water supply pipelines, or a predetermined section or length thereof that is to be rehabilitated, wherein the plug arrangement comprises an optional plugging portion adapted to be inserted into a tapping point or side inlet and a covering or collar-shaped portion having a predetermined suitable shape with a peripheral area or surface adapted to cover, around the tapping point, a certain or predetermined area of an inner wall of a pipeline.

11. Plug arrangement according to claim 10, wherein at least a part of the area or side of the covering or collar-shaped portion or part, facing the inner pipe wall, is saturated or applied with an adhesive to contribute for tight sealing associated with the tapping point.

12. Plug arrangement according to claim 10, wherein the covering or collar-shaped portion or part is flexible in such a way that it would be able to fit with or take the form or shape of the inner pipe wall, and has a circular, elliptical, or rectangular shape.

13. Plug arrangement according to claim 10, further comprising a marking means adapted to be detectable in connection with removing the plug arrangement and arranged onto or within the plug arrangement, particularly the covering or collar-shaped part thereof, so that the marking means is able to define the center of the tapping point or hole.

14. Plug arrangement according to claim 10, wherein the marking means is physically or chemically detectable by a detecting means.
